(19) United States
(12) Patent Application Publication
(10) Pub. No.: US 2019/0210681 A1
(43) Pub. Date: Jul. 11, 2019

(54) SMART DEVICE-BASED IoT SAFETY SYSTEM FOR BICYCLE RIDING

(71) Applicant: INDUSTRY-ACADEMIC COOPERATION FOUNDATION CHOSUN UNIVERSITY, Gwangju (KR)

(72) Inventors: Ju Hyun SHIN, Gwangju (KR); Jun Seok CHA, Gwangju (KR); Seung Min HAN, Gwangju (KR); Seung Hyeon BAK, Gwangju (KR)

(21) Appl. No.: 15/500,321

(22) PCT Filed: Nov. 29, 2016
(86) PCT No.: PCT/KR2016/013861

§ 371 Date: Jan. 30, 2017

(30) Foreign Application Priority Data
Aug. 17, 2016 (KR) 10-2016-0104190

(51) Int. Cl. B62J 99/00; B62J 3/00; B62J 6/04; B60Q 1/26; B60Q 5/00; B60Q 9/00

(52) U.S. Cl. CPC B62J 99/00; B62J 3/00; B62J 6/04; B60Q 1/26; B62J 2099/008; B60Q 9/00; B62J 2099/0006; B62J 2099/0026; B60Q 5/005

(57) ABSTRACT

A safety system for bicycle riding is capable of preventing collision of a bicycle by generating vibrations to alert a rider to a dangerous situation when a front object is detected within a collision risk distance and is capable of reducing accidents by emitting a light beam to alert a driver of a rear object to a dangerous situation when the rear object is closely approaching.

### TECHNICAL FIELD

The present invention relates to a safety system for bicycle riding and. More particularly, the present invention relates to a safety system for bicycle riding whereby the safety system is capable of preventing collision of a bicycle by generating vibrations to alert a rider to a dangerous situation when a front object is detected within a collision risk distance and is capable of reducing accidents by emitting a light beam to alert a driver or rider of a rear object to a dangerous situation when the rear object is closely approaching.

### BACKGROUND ART

Presently, due to an increase in the number of vehicles being used, there are problems such as severe environment pollution and fossil fuel crisis, resulting in a dramatic increase in oil price. For this reason, use of bicycles is recommended for short-distance movement to save energy. As a result, the number of bicycle riders is increasing.

In addition, usage of a bicycle has changed from a vehicle for short-distance movement to a kind of sports equipment for aerobic exercise. That is, the number of people using a bicycle as sports equipment is rapidly increasing.

For safe bicycle riding, a bicycle rider typically wears protection gear or equips his or her bicycle with a tail light. However, with only these measures, safeguards for accident prevention are insufficient.

Furthermore, there is an increasing number of riders listening to music or watching a screen of a smart device while riding a bicycle due to recent development of smart devices. Therefore, there is an increase in accidents attributable to riders being distracted.

### DISCLOSURE

### Technical Problem

Accordingly, the present invention has been made keeping in mind the above problems occurring in the related art, and an object of the present invention is to provide a safety system for bicycle riding, the system generating vibrations to alert a rider to a dangerous situation when a rider fails to recognize a dangerous situation due to being distracted during riding, thereby aiding the rider in safe riding.

Another object of the present invention is to provide an IoT safety system for bicycle riding, the system determining a dangerous situation using a detection sensor and a smart device such as a smart phone installed on a bicycle and controlling a vibration-generating device and a lighting device.

A further object of the present invention is to provide a safety system for bicycle riding, the system effectively alerting a rider to a dangerous situation by displaying “a distance to a front object” (hereinafter, referred to as a forward distance) or “a distance to a rear object” (hereinafter, referred to as a backward distance), on a screen of a smart device.

A yet further object of the present invention is to provide a safety system for bicycle riding, the system changing a pattern of flashing of a lighting device according to the backward distance, thereby effectively alerting a following rider or driver so that the following rider or driver can easily recognize the location of a bicycle ahead, thus minimizing an accident risk.

### Technical Solution

In order to accomplish the objects of the present invention, according to one aspect, there is provided a safety system for bicycle riding, the system including: a front sensor attached to a front portion of a bicycle and detecting a position of an object (hereinafter, referred to as a front object) in front of the bicycle; a rear sensor attached to a rear portion of the bicycle and detecting a position of an object (hereinafter, referred to as a rear object) behind the bicycle; and a controller attached to a portion of the bicycle, receiving detection signals from the front sensor and the rear sensor, and transmitting the received detection signals to a rider's smart device, wherein an application is installed in the smart device and causes the smart device to function as a distance information output unit that outputs the detection signal received from the controller as a distance between the bicycle and the front or rear object.

In the preferred embodiment, the application may cause the smart device to function as a detection distance setting unit that transmits a detection distance setting signal for setting a detection distance of the front sensor or rear sensor.

In the preferred embodiment, the safety system may further include a vibration-generating device attached to a handlebar of the bicycle and generating vibrations in the handlebar, wherein the controller operates the vibration-generating device when a distance (hereinafter, referred to as “forward distance”) between the front sensor and the front object is equal to or shorter than a critical distance (hereinafter, referred to as “forward critical distance”).

In the preferred embodiment, the application may cause the smart device to further function as a vibration setting unit that sets whether the controller operates the vibration-generating device or not.

In the preferred embodiment, the safety system may include a lighting device attached to a rear portion of the bicycle, wherein the controller operates the lighting device when a distance (hereinafter, referred to as “backward distance”) between the rear sensor and the rear object is equal to or shorter than a critical distance (hereinafter, referred to as “backward critical distance”).

In the preferred embodiment, the controller may change a pattern of flashing of the lighting device 10 according to the backward distance.

In the preferred embodiment, the application may cause the smart device to function as a flashing setting unit that sets whether the controller operates the lighting device or not.

In the preferred embodiment, the controller may control the lighting device such that the lighting device continuously emits a light beam or intermittently flashes on and off according to the backward distance.

In the preferred embodiment, the lighting device may be an LED lamp.

In the preferred embodiment, the application may cause the smart device to function as an alert notification output unit that alerts a rider via an image or speech when the forward distance is equal to or shorter than the forward critical distance or when the backward distance is equal to or shorter than the backward critical distance.

### Advantageous Effects

The present invention has advantages described below.

First, according to the safety system for bicycle riding of the present invention, when a rider fails to recognize a front object due to being distracted during riding, the system causes vibrations so that the rider can recognize a dangerous situation by touch.

Second, the safety system for bicycle riding of the present invention operates based on Internet of Things (IoT) technology. The system determines a dangerous situation using the smart device by receiving the forward distance or the backward distance, from the front sensor or the sensor, and wirelessly controls the vibration-generating device and the lighting device via the controller.

Third, according to the safety system for bicycle riding of the present invention, the forward distance or the backward distance is displayed on the screen of the smart device. Therefore, the present invention has an effect of effectively alerting a rider to a dangerous situation.

Finally, according to the safety system for bicycle riding of the present invention, the lighting device changes its flashing pattern according to a distance to a rear object that is approaching from behind. For example, the lighting device may intermittently flash on and off, thereby enabling a following rider or deriver to effectively recognize the location of the bicycle ahead.

### DESCRIPTION OF DRAWINGS

FIG. 1 is a safety system for bicycle riding according to one embodiment of the present invention;

FIG. 2 is a diagram for describing an application installed in a smart device that is one element of the safety system for bicycle riding according to one embodiment of the present invention;

FIG. 3 is a diagram illustrating a screen displayed on the smart device of the safety system for bicycle riding according to one embodiment of the present invention, the screen being a forward distance information output screen in which information of a distance to a front object is displayed;

FIG. 4 is a diagram illustrating a screen displayed on the smart device of the safety system for bicycle riding according to one embodiment of the present invention, the screen being a forward alert notification screen;

FIG. 5 is a diagram illustrating a screen displayed on the smart device of the safety system for bicycle riding according to one embodiment of the present invention, the screen showing a backward distance information output screen in which information of a distance to a rear object is displayed;

FIG. 6 is a diagram illustrating a screen displayed on the smart device of the safety system for bicycle riding according to one embodiment of the present invention, the screen being a backward alert notification screen;

FIG. 7 is a diagram illustrating a screen for changing settings of the smart device of the safety system for bicycle riding according to one embodiment of the present invention;

FIG. 8 is a flowchart showing operation sequence of a vibration-generating device of the safety system for bicycle riding according to one embodiment of the present invention; and

FIG. 9 is a flowchart showing operation sequence of a lighting device of the safety system for bicycle riding according to one embodiment of the present invention.

### DESCRIPTION OF THE REFERENCE NUMERALS IN THE DRAWINGS

10: Bicycle
20: Front object
30: Rear object
100: Safety system for bicycle riding
110: Front sensor
120: Rear sensor
130: Controller
140: Smart device
150: Vibration-generating device
160: Lighting device

### BEST MODE

Although most of the terms used herein have the same meaning as commonly understood by ordinary people, some terms herein are specifically defined by the applicant. When terms used herein are different from the commonly understood meaning, the terms will be interpreted as having a meaning that is consistent with their meaning in the context of the related art and the present disclosure.

Hereinafter, the technical configuration of the present invention will be described with reference to preferred embodiments illustrated in the accompanying drawings.

However, the preferred embodiments are disclosed only for illustrative purposes and thus should not be construed as limiting the present invention. That is, the present invention can be embodied in different forms. Throughout the drawings, the same reference numerals will refer to the same or like parts.

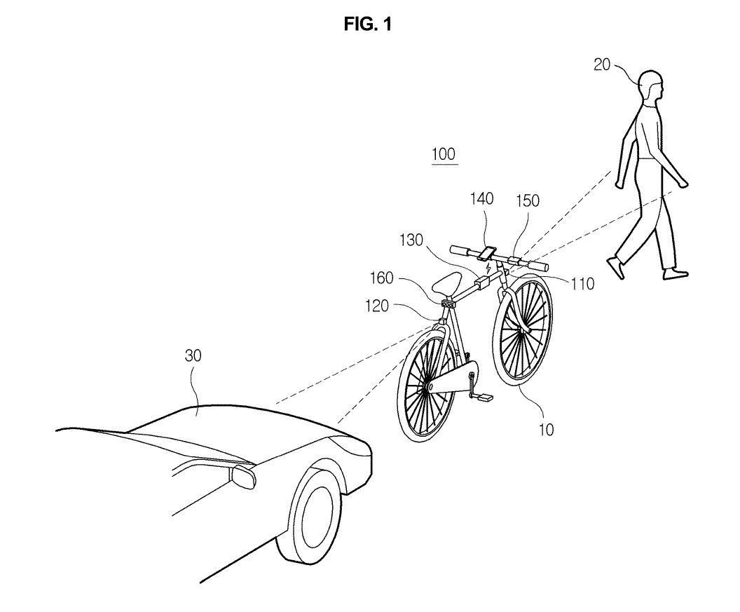

With reference to FIG. 1, according to one embodiment of the present invention, a safety system 100 for bicycle riding is a system for detecting a front object 20 and a rear object 30 during riding of a bicycle 10, displaying information of distances to the front object 20 and the rear object 30 via a smart device 140, and outputting an alert notification when the front object 20 or the rear object 30 is within a critical distance.

In addition, the safety system 100 causes vibrations in a handlebar of the bicycle 10 with the use of the smart device 140 when the distance between the bicycle 10 and the front object 20 is equal to or shorter than the critical distance, thereby alerting a rider of the bicycle 10 to a dangerous situation. In addition, the safety system 100 emits a light beam in a backward direction of the vehicle 10 to alert a driver or rider of the rear object 20 to a dangerous situation when the rear object 20 closely approaches the bicycle 10 to be within the critical distance, thereby reducing an accident risk.

That is, the safety system 100 is an IoT safety system using the smart device 140. The IoT safety system aims at safe riding of a bicycle (IoT is an acronym for Internet of Things).

Hereinafter, the construction of the safety system 100 for bicycle riding according to one embodiment of the present invention 100 will be described in detail.

The safety system 100 for bicycle riding according to one embodiment of the present invention includes a front sensor 110, a rear sensor 120, a controller 130, and a smart device 140. Applications for causing the smart device 140 to control the controller 130 are installed in the smart device 140. The applications can cause the smart device 140 to output information, received from the controller 130, via a display or a speaker of the smart device 140.

In addition, the safety system 100 for bicycle riding may further include a vibration-generating device 150 and a lighting device 160, and the smart device 140 controls the vibration-generating device 150 and the lighting device 160 via the controller 130.

The front sensor 110 is a distance sensor installed at a front portion of a body of the bicycle 10 to detect the front object 20.

For example, the front sensor 110 can be an ultrasonic sensor. However, the front sensor 110 is not specifically limited in its kind if it can detect a distance.

In addition, the front sensor 110 can be attached to a handlebar of the bicycle 10. However, this is not recommended because, in this case, it is difficult to detect a front object when the handlebar is rotated.

In addition, the front sensor 110 is controlled by the controller 130 and transmits a detection signal to the controller 130.

The rear sensor 120 is a distance sensor that is installed at a rear portion of the body of the bicycle 10 to detect the rear object 30.

Alternatively, the rear sensor 120 may be attached to a seat instead of a rear portion of the body of the bicycle 10. As to an installation position of the rear sensor 120, there is no specific limitation. The rear sensor 120 can be installed at any position to which the rear sensor 120 can be fixed.

In addition, the rear sensor 120 can be an ultrasonic sensor. However, the rear sensor 120 is not specifically limited in its kind if the rear sensor 120 can detect a distance.

In addition, the rear sensor 120 is controlled by the controller 130 and transmits a detection signal to the controller 130.

The controller 130 is attached to a portion of the body of the bicycle 10, and transmits detection signals received from the front sensor 120 and the rear sensor 130 to the smart device 140.

In addition, the controller 130 and the smart device 140 can exchange data through wireless communication. For example, the controller 130 and the smart device 140 can communicate with each other via Bluetooth communication.

In addition, the controller 130 can be connected to the front sensor 120 and the rear sensor 130 in a wired or wireless manner.

In addition, preferably, the front sensor 110, the rear sensor 120, and the controller 130 are detachably attached to the bicycle 10.

This is to enable a rider to remove these sensors and controller from the bicycle 10 so that the rider can use these sensors and controller for his or her other bicycles or can keep these sensors and controller in a space place not to be stolen or lost.

The smart device 140 is a mobile smart device owned by a rider. Examples thereof include a smart phone and a tablet PC.

The smart device 140 may not be a ready-made product but be a custom-made hardware assembly provided with a wireless communication function.

In addition, an application for causing the smart device 140 to control the controller 130 and to process information transmitted by the controller 130 is installed in the smart device 140.

In addition, the application may be provided as stored in a recording medium that can be read by the smart device 140 or a computer. The recording medium is a dedicated recording medium specifically designed for the present invention or a recording medium that is well-known to those ordinarily skilled in the art of computer software.

For example, the recording medium may be a hardware device specially constructed to store and execute program instructions or commands singly or in combination. Examples of the recording medium may include: an electromagnetic medium such as hard disk, floppy disk, or magnetic tape; an optical recording medium such as compact disk (CD) or digital versatile disk (DVD); a magneto-optical recording medium that can store data magnetically and optically; and a memory device such as ROM, RAM, or flash memory.

In addition, the application may be a program involving any one component of program instructions or commands, local data files, and local data structures. The application may be a program written in machine codes derived by a compiler or in high level language codes that can be executed by a computer with the aid of an interpreter.

The vibration-generating device 150 is installed in the handlebar of the bicycle 10 and generates vibrations.

In addition, the vibration-generating device 150 may be an actuator capable of generating vibrations via a motor, ultrasonic waves, or magnetic force. The vibration-generating device 150 is not limited in its kind if it can generate vibrations.

In addition, the vibration-generating device 150 is controlled by the controller 130.

The lighting device 160 is installed at a rear portion of the body of the bicycle 10 or on a seat of the bicycle 10 and emits a light beam in a backward direction.

In addition, the lighting device 160 can be an LED lamp and is controlled by the controller 130.

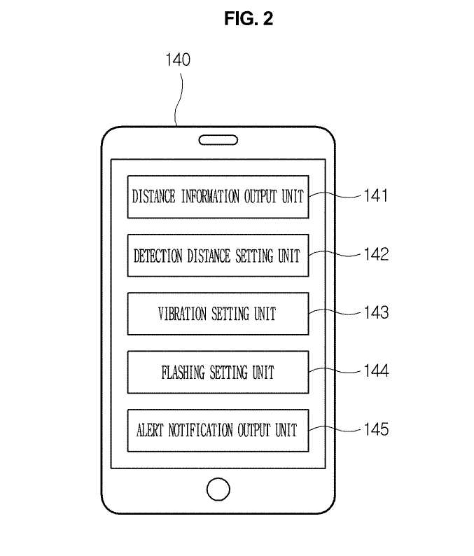

Hereinafter, with reference to FIG. 2, functions of the application installed in the smart device 140 will be described in detail.

With reference to FIG. 2, the application causes the smart device 140 to function as a distance information output unit 141, a detection distance setting unit 142, a vibration setting unit 143, a flashing setting unit 144, and an alert notification output unit 145.

The distance information output unit 141 receives detection signals detected by the front sensor 110 and the rear sensor 120 from the controller 130, and outputs the detection signals via a display.

In addition, the detection signal may be distance information or a signal value of a predetermined intensity. When the detection signal is a predetermined signal value, it is converted into distance information and the distance information is provided via the display.

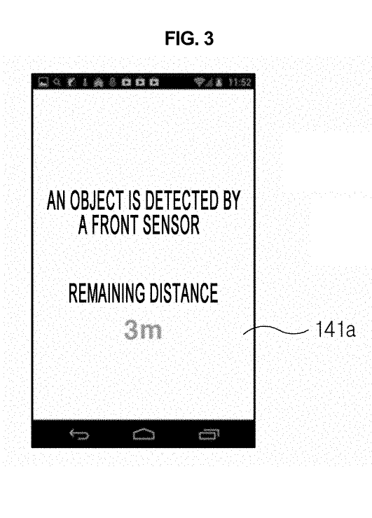

FIG. 3 shows a forward distance information output screen 141a provided by the distance information output unit 141. The forward distance information output screen 141a displays “a distance to a front object” (hereinafter, referred to as “a forward distance”) and a message reading “a front object is detected”.

In addition, the distance information output unit 141 can output the forward distance via speech instead of an image.

In addition, FIG. 5 illustrates a backward distance information output screen 141b provided by the distance information output unit 141. The backward distance information output screen 141b displays “a distance to a rear object” (hereinafter, referred to as “a backward distance”) and a message reading “a rear object is detected”.

In addition, the distance to the rear object 30 also can be output via speech.

The detection distance setting unit 142 sets detection distances of the front sensor 110 and the rear sensor 120 and an operation state (on or off) of the sensors 110 and 120 via the controller 130.

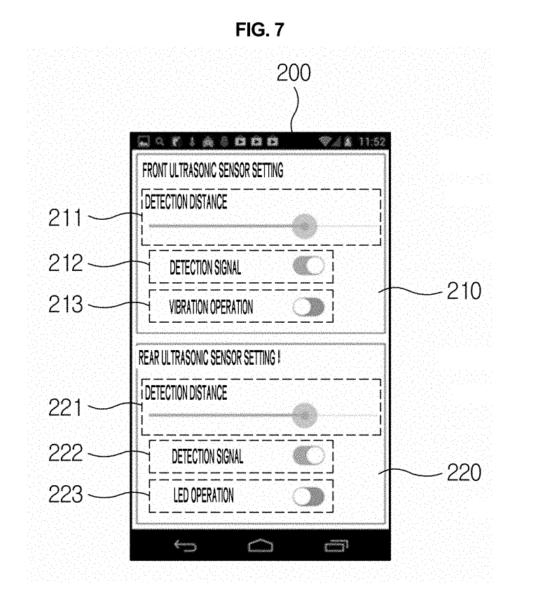

In addition, the detection distance setting unit 142 allows a user to enter values of detection distances into a forward detection distance setting input box 211 and a backward detection distance setting input box 221 in the setting screen 200 of FIG. 7. The detection distances that are set via the detection distance setting input boxes 211 and 221 are distances that can be detected by the front sensor 110 and the rear sensor 120.

The detection distances may be distances within which there is a collision risk. In this case, the detection distances can be referred to as a forward critical distance and a backward critical distance.

That is, the detection distance setting unit 142 receives a forward detection distance, which is a range of a distance that can be measured by the front sensor 110, or a forward critical distance within which the bicycle is highly likely to collide with the front object 20, via the forward detection distance setting input box 211. The detection distance setting unit 142 also receives a backward detection distance, which is a range of a distance that can be measured by the rear sensor 120, or a backward critical distance within which the bicycle is highly likely to collide with the rear object 30, via the backward detection distance setting input box 221.

In addition, the detection distance setting unit 142 transmits a detection distance setting signal for setting the detection distances to the controller 130, and the controller 130 sets the detection distances (i.e., sensitivity) of the front sensor 110 and the rear sensor 120.

In addition, the detection distance setting unit 142 sets an operation state (on or off) of the front sensor 10 or the rear sensor 120, via a front sensor operation setting input box 212 and a rear sensor operation setting input box 220 in the setting screen 200 of FIG. 7.

The vibration setting unit 143 is an element to set a condition in which the vibration-generating device 150 operates. The vibration setting unit 143 sets the controller 130 such that the vibration-generating device 150 operates when the distance to the front object 20, measured by the front sensor 110, is within the forward critical distance.

In addition, the vibration setting unit 143 can set an operation state (on or off) of the vibration-generating device 150 via a vibration setting input box 213 in the setting screen 200 of FIG. 7.

The flashing setting unit 144 is an element to set a condition in which the lighting device 160 operates. The flashing setting unit 144 sets the controller 130 such that the lighting device 160 operates when the distance to the rear object 30, measured by the rear sensor 120, is within the backward critical distance.

In addition, the flashing setting unit 144 can set the controller 130 such that a pattern of flashing of the lighting device 160 changes according to the distance to the rear object 30.

For example, when the rear sensor 120 detects the rear object 30, the lighting device 160 continuously emits a light beam, but when the rear object 30 closely approaches the bicycle 10 within the forward critical distance, the lighting device 160 repeatedly flashes on and off.

This has an advantage of effectively informing a rider of the rear object 30 of a situation in which the rear object 30 is within a collision risk distance with respect to the bicycle 10.

In addition, the flashing setting unit 144 can set an operation state (on or off) of the lighting device 160 via the setting screen 200 of FIG. 7.

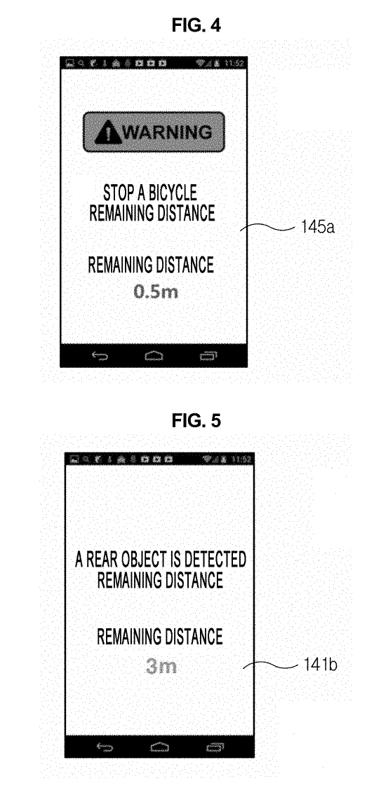

The alert notification output unit 145 provides a forward alert notification screen 145a of FIG. 4 when the front object 20 is detected within the forward critical distance.

In addition, the forward alert notification screen 145a shows a message requiring stopping of a bicycle and information of a distance to the front object 20.

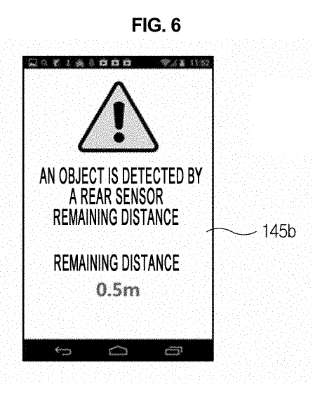

In addition, the alert notification output unit 145 can provide a backward alert notification screen 145b of FIG. 6 when the rear object 30 closely approaches or is within the backward critical distance. The backward alert notification screen 145b can show a message reading “a rear object is detected” and information of a distance to the rear object 30.

In addition, the alert notification output unit 145 can output alert speech as well as an alert notification image such as the forward alert notification screen 145a and the backward alert notification screen 145b. In this case, a rider can effectively recognize a dangerous situation even without viewing the smart device 140.

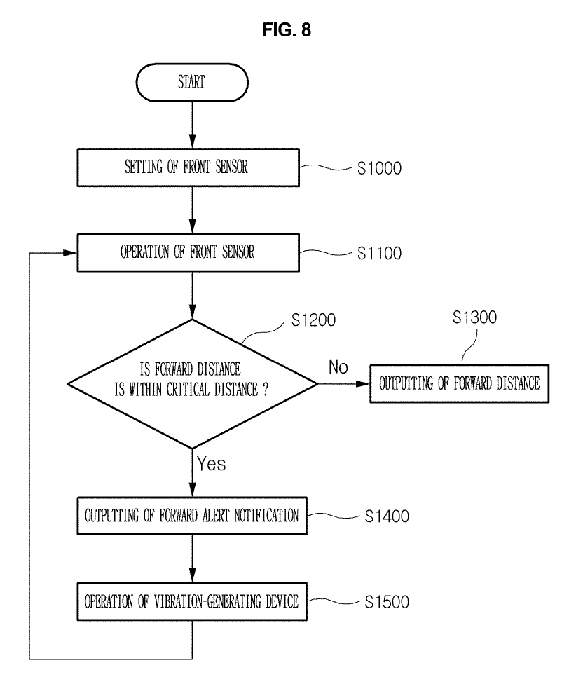

FIG. 8 is a flowchart showing operation sequence of the vibration-generating device 150. With reference to FIG. 8, first, the detection distance setting unit 142 sets a detection distance of the front sensor 110 and an operation state (or off) of the front sensor 110 (Step S1000).

The detection distance may include the forward distance (distance to a front object) and the forward critical distance.

Next, the front sensor 110 is operated (Step S1100), and the bicycle 10 is ridden.

Next, when the front object 20 appears in front of the bicycle 10 and when the front sensor 110 detects the front object 20, it is determined whether a distance to the front object 20 is within the forward critical distance in which there is a collision risk (Step S1200).

When the front object 20 is not within the forward critical distance, information of the distance to the front object is displayed in the forward distance information output screen 141a (Step S1300), and the process is returned to Step S1200 at which it is monitored whether the front object 20 becomes closer to be within the forward critical distance.

When the front object 20 becomes closer to be within the forward critical distance, a forward alert notification is provided via the forward alert notification screen 145a (Step S1400), and then the vibration-generating device 150 is operated (Step S1500).

Here, the forward alert notification and vibrations can be simultaneously provided. Alternatively, the vibrations are generated first and then the forward alert notification is provided.

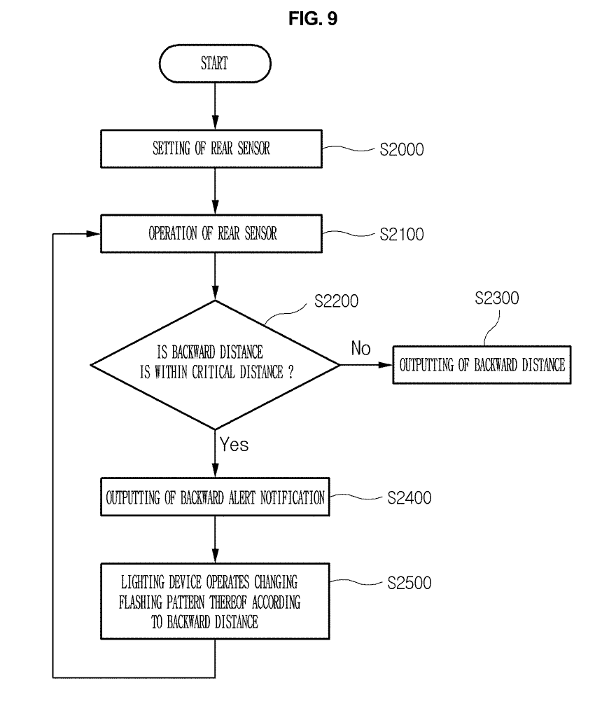

FIG. 9 is a flowchart showing operation sequence of the lighting device 160. With reference to FIG. 9, the detection distance setting unit 142 sets a detection distance of the rear sensor 120 and an operation state (on or off) of the rear sensor 120 (Step S2000).

In addition, the detection distance detected by the rear sensor 120 may include the backward distance (distance to a rear object) and the backward critical distance.

Next, the rear sensor 120 is operated (Step S2100), and the bicycle 10 is ridden.

Next, when the rear object 30 appears behind the bicycle 10 and is detected by the rear sensor 120, it is monitored whether the rear object 20 enters a range of the backward critical distance within which there is a collision risk (Step S2200).

When the rear object 20 is outside the backward critical distance, the backward distance information output screen 141b is displayed (Step S2300), and the process is returned to Step S2200 at which it is monitored whether the rear object 20 closely approaches or is within the backward critical distance.

However, when the rear object 30 closely approaches the backward critical distance, the backward alert notification screen 145b is displayed (Step S2400), and the lighting device 160 flashes on and off (Step S2500).

Here, the display of the backward alert notification screen 145b and the flashing of the lighting device 160 may be provided in arbitrary order, for example, can be simultaneously performed.

In addition, the lighting device 160 can change the pattern of flashing according the distance to rear object 30. For example, when the distance to the rear object 30 is equal to or shorter than the backward critical distance, the lighting device 160 continuously emits a light beam. When the distance becomes further shorter, the lighting device 160 may flash on and off.

Alternatively, the lighting device 160 may start emitting a light beam when the rear object 30 is detected and then flash on and off when the rear object 30 closely approaches or is within backward critical distance.

Although a preferred embodiment of the present invention has been described for illustrative purposes, those skilled in the art will appreciate that various modifications, additions and substitutions are possible, without departing from the scope and spirit of the invention as disclosed in the accompanying claims.

### INDUSTRIAL APPLICABILITY

The safety system for bicycle riding according to the present invention can be applied to a bicycle, thereby reducing accidents during bicycle riding.

1. A safety system for bicycle riding, the system comprising:
a front sensor attached to a front portion of a bicycle and detecting a position of a front object defined as an object in front of the bicycle;
a rear sensor attached to a rear portion of the bicycle and detecting a position of a rear object defined as an object behind the bicycle; and
a controller attached to a portion of the bicycle, receiving detection signals from the front sensor and the rear sensor, and transmitting the received detection signals to a rider's smart device,
wherein an application is installed in the smart device, the application causing the smart device to function as a distance information output unit that outputs the detection signal received from the controller as a distance between the bicycle and the front or rear object.

2. The safety system according to claim 1, wherein the application causes the smart device to function as a detection distance setting unit that transmits a detection distance setting signal for setting a detection distance of the front sensor or rear sensor.

3. The safety system according to claim 1, further comprising a vibration-generating device attached to a handlebar of the bicycle and generating vibrations in the handlebar, wherein the controller operates the vibration-generating device when a forward distance defined as a distance between the front sensor and the object is equal to or shorter than a first critical distance.

4. The safety system according to claim 3, wherein the application causes the smart device to further function as a vibration setting unit that sets whether the controller operates the vibration-generating device or not.

5. The safety system according to claim 4, further comprising a lighting device attached to a rear portion of the bicycle, wherein the controller operates the lighting device when a backward distance defined as a distance between the rear sensor and the rear object is equal to or shorter than a second critical distance.

6. The safety system according to claim 5, wherein the controller changes a pattern of flashing of the lighting device according to the backward distance.

7. The safety system according to claim 5, wherein the application causes the smart device to function as a flashing setting unit that sets whether the controller operates the lighting device or not.

8. The safety system according to claim 6, wherein the controller causes the lighting device to continuously emit a light beam or intermittently flash on and off according to the backward distance.

9. The safety system according to claim 6, wherein the lighting device is a light-emitting diode (LED) lamp.

10. The safety system according to claim 5, wherein the application causes the smart device to function as an alert notification output unit that alerts a rider via an image or speech when the forward distance is equal to or shorter than the first critical distance or when the backward distance is equal to or shorter than the second critical distance.

11. The safety system according to claim 2, further comprising a vibration-generating device attached to a handlebar of the bicycle and generating vibrations in the handlebar, wherein the controller operates the vibration-generating device when a forward distance defined as a distance between the front sensor and the object is equal to or shorter than a first critical distance.

12. The safety system according to claim 11, wherein the application causes the smart device to further function as a vibration setting unit that sets whether the controller operates the vibration-generating device or not.

13. The safety system according to claim 12, further comprising a lighting device attached to a rear portion of the bicycle, wherein the controller operates the lighting device when a backward distance defined as a distance between the rear sensor and the rear object is equal to or shorter than a second critical distance.

14. The safety system according to claim 13, wherein the controller changes a pattern of flashing of the lighting device according to the backward distance.

15. The safety system according to claim 13, wherein the application causes the smart device to function as a flashing setting unit that sets whether the controller operates the lighting device or not.

16. The safety system according to claim 14, wherein the controller causes the lighting device to continuously emit a light beam or intermittently flash on and off according to the backward distance.

17. The safety system according to claim 14, wherein the lighting device is a light-emitting diode (LED) lamp.

18. The safety system according to claim 13, wherein the application causes the smart device to function as an alert notification output unit that alerts a rider via an image or speech when the forward distance is equal to or shorter than the first critical distance or when the backward distance is equal to or shorter than the second critical distance.
